(19) United States
(12) Patent Application Publication
(10) Pub. No.: US 2009/0038328 A1
(43) Pub. Date: Feb. 12, 2009

(54) Coil with Built-In Primary and Auxiliary Drain Pans and Method

(76) Inventor: David Piccione, Humble, TX (US)

Correspondence Address: KENNETH L. NASH, P.O. BOX 680106, HOUSTON, TX, 77268-0106, US

(21) Appl. No.: 12/174,813

(22) Filed: Jul. 17, 2008

Related U.S. Application Data
(60) Provisional application No. 60/963,767, filed on Aug. 7, 2007.

(51) Int. Cl. F25D 21/14; F25B 39/02; B23P 15/26

(52) U.S. Cl. 62/291; 62/515; 29/890.035

(57) ABSTRACT

An air-conditioning system provides a primary drain pan built in beneath an evaporator coil with primary drain lines. An auxiliary drain pan is built into the air conditioning system to receive overflow condensate from the primary drain pan and drains through auxiliary drain lines. The built-in auxiliary drain pan and primary drain pan are plumb with respect to each other. The assembly construction thereby provides reduced time and costs associated with storing, transporting, installing, leveling, and plumbing individual components.

### BACKGROUND OF THE INVENTION

1. Field of the Invention

The present invention relates generally to air-conditioning systems and more particularly, to a coil housing wherein multiple drain pans such as primary and overflow drain pans are built into the coil.

2. Description of the Prior Art

Generally, refrigeration systems employ an evaporator, condenser, fluid control device, compressor, and motor-driven fan, which carries air across evaporator coils. The most common type of air conditioning system is the “split” system, also called a “central” air conditioning system where the condenser is located outside and the evaporator is located inside.

In the split system, the condenser cools the refrigerant using the ambient air outside of the home (or other conditioned space). That refrigerant is then carried into the home where it passes through the evaporator coils. Inside the air handling unit (AHU), a motor-driven fan passes air from within the conditioned space over the coils, transferring heat from the inside air to the coils thereby cooling the conditioned space. This system is favored in humid climates for its ability to dehumidify the conditioned space. During the refrigeration cycle, moisture condenses on the evaporator coils and drips off within the AHU. This condensation is typically recovered by a drain pan and disposed of via a drain line to the outside or a plumbing system.

Drain lines can become occluded by mold or other microbial growth, rust, or debris, resulting in overflow of the drain pan. AHUs are often installed in residential attics, where overflows can result in considerable damage to a home's interior. A number of methods have been developed to prevent such damage.

For example, use of an overflow drain pan for various components of heating and cooling systems is well known. It has long been the practice of installers to fashion a suitable system of drain pans when installing a coil. This practice requires significant additional time and cost over the cost of the coil.

One installation method includes a secondary drain line installed slightly higher on the drain pan than the primary drain line to act as a backup in case the primary becomes occluded. Examples employing this method include, U.S. Pat. No. 5,715,697 to Rust et al., U.S. Pat. No. 5,904,053 to Polk et al., Pub. No. 20050109055 by Goetzinger et al., and U.S. Pat. No. 5,987,909 to Martin, Sr.

U.S. Pat. No. 5,715,697, issued to Rust et al. on Feb. 10, 1998, entitled “Condensate Pan with Minimal Residual Condensate,” discloses a condensate pan adapted for use in either a left or right horizontal fan coil installation, including left and right mirror image sides interconnected with a central section having on its lower surface a riser near one end, and each of the halves having a drainage opening on the other end, such that when the evaporator coil is placed in the condensate pan, the pan is tipped about the riser to lower one side and raise the other, depending on whether its a left or right horizontal installation, such that drainage occurs from the lower side drainage opening. The drainage opening is so located with respect to the floor of the pan that, when a drainpipe is threadably connected thereto, its lower inner surface is disposed vertically below the pan floor.

U.S. Pat. No. 5,904,053, issued to Polk et al. on May 18, 1999, entitled “Drainage Management System for Refrigeration Coil,” discloses a refrigeration system including an evaporator coil with a drain pan having alternative drain openings which receive movable primary and secondary drain plugs. A drain pan for use with horizontal A-coils is provided with alternative drain pan openings permitting a variety of configurations whereby the evaporator coil may be oriented in the space conditioning system in the most effective manner depending upon on-site conditions. A combination horizontal coil support and drainage duct with coil baffle provides a channel for effective communication of drainage fluid from the coil to the drain pan.

U.S. Publication No. 20050109055, published May 26, 2005 discloses a drain pan for capturing condensate from a cooling coil in an air conditioning system, con FIG. d to facilitate condensate drainage from the pan and to inhibit accumulation of condensate therein. The pan includes troughs for collecting condensate and for channeling the condensate to the front part of the pan where the drain openings are located. A back trough has a central hump to enhance the flow of condensate from the back trough in both directions into opposed side troughs. The side troughs are sloped from back to front to conduct the condensate into a front trough to facilitate drainage from the pan. The lowermost portion of the front trough region is defined by a relatively narrow, non-flat area to reduce the amount of condensate residue in the pan.

U.S. Pat. No. 5,987,909, issued to Martin, Sr. on Nov. 23, 1999, entitled “Air Conditioner Drain Pan,” discloses a multi-pan for an air conditioning system which has a coil positionable in one of three orientations has been invented, the multi-pan includes, in certain aspects, a bottom pan having walls defining an inner space the bottom pan disposed for receiving water from the coil when the coil is positioned above the bottom pan, a first side pan connected at one end to the bottom pan, the first side pan disposed for receiving water from the coil when the coil is positioned above the first side pan, and a second side pan connected at one end to the bottom pan and spaced apart from the first side pan by the bottom pan, the second side pan disposed for receiving water from the coil when the coil is positioned above the second side pan the bottom pan can be con FIG. d for an A (or V) coil with an air flow space therethrough, or for an M-coil with two air flow spaces therethrough and a middle pan part.

While this method consists of three individual drain pans, only one is utilized in any single orientation of the coils. Therefore, no redundancy is achieved.

Any of these methods, however, cannot address additional problems where drain pans can rust or overflow if the evaporator is being thawed after a recent system freeze. In response to these problems, installers have employed a second, auxiliary, drain pans outside, and beneath, the AHUs to catch overflow from the primary drainpan. An example of this method includes, U.S. Pat. No. 6,895,770 to Kaminski.

U.S. Pat. No. 6,895,770, issued to Kaminski on May 24, 2005, entitled “Condensate Secondary Pan for a Central Air Conditioner System,” discloses a secondary condensate pan for a central air conditioning system whereby overflow protection of the primary condensate removal system for a fan coil unit of a central air conditioning system is realized. The secondary pan is positioned directly beneath the primary pan of the central air conditioning system to convey condensate safely outside an enclosure should the primary pan overflow due to clogging of the primary drain line, or leak due to cracks or fissures formed in the primary pan. The condensate secondary pan has a predetermined girth sufficient to extend laterally beyond the primary pan of a conventional fan coil unit. The condensate secondary pan also has a bottom panel which is frustoconical in shape, thus minimizing the pooling of condensate on its surface as well as an integral drain pipe connecting means, thereby eliminating the need for a superfluous user supplied connecting means which is typically made of metal and thus is susceptible to corrosion.

While more redundant, this cited method requires the additional cost and time associated with, purchasing, storage, transporting, installation, and plumbing the additional components. Additionally, the external auxiliary drain pans must be leveled and plumbed separately or they could also overflow.

The same principles described above apply in a heat pump system like the one disclosed in U.S. Pat. No. 6,519.966. U.S. Pat. No. 6,519.966, issued to Martin, Sr., entitled “Air conditioning and Heat Pump System,” discloses an air treatment system having an outer heat exchange coil, an inner heat exchange coil spaced-apart from and encompassed by the outer heat exchange coil, seal structure positioned with respect to both coils so that air pulled through the air treatment system by air movement apparatus may flow through the inner heat exchange coil without flowing through the outer heat exchange coil; and in one aspect, an air treatment system having an outer heat exchange coil; an inner heat exchange coil within the outer heat exchange coil; the inner coil spaced-apart from the outer heat exchange coil; the inner heat exchange coil and the outer heat exchange coil defining an inner chamber therebetween; the inner chamber positioned so that air exhaust apparatus above the inner heat exchange coil moves air into the inner chamber for exhausting therefrom by the air exhaust apparatus; air flowing from outside the outer heat exchange coil, through the outer heat exchange coil, and into the inner chamber; and air Flowing from outside the housing between spaced-apart ends of the inner heat exchange coil to within the inner heat exchange coil, through the inner heat exchange coil, and into the inner chamber.

U.S. Pat. No. 5,062,280, issued Nov. 5, 1991, to Martin, Sr. discloses an air conditioning apparatus with an enclosure which both houses a conditioning coil and serves as a plenum for transferring air to one or more conduits. In one aspect, vanes of the coil or coils are oriented to direct air toward openings in the plenum. An enclosure serves as a coil housing and as a plenum.

U.S. Pat. No. 6,276,443, issued Aug. 21, 2001, to Martin, Sr. discloses An air conditioning coil system having a first and a second outside tubing slab, a first and a second inside tubing slab, the inside tubing slabs positioned between the outside tubing slabs, a top of the first outside tubing slab contacting a top of the first inside tubing slab, a top of the second outside tubing slab contacting a top of the second inside tubing slab, and a bottom of the first inside tubing slab contacting a bottom of the second inside tubing slab, each tubing slab having a plurality of spaced-apart heat exchange fins, each outside tubing slab having a plurality of spaced-apart tubing rows extending through he plurality of heat exchange fins of the corresponding outside tubing slab, and each inside tubing slab having at least one tubing row extending through the plurality of heat exchange fins of the corresponding inside tubing slab. The air conditioning coil system wherein the at least one tubing row of each inside tubing slab is one row less than the number of tubing rows of the plurality of spaced-apart tubing rows in one of the outside tubing slabs.

U.S. Pat. No. 6,664,431, issued Sep. 9, 1997, to Martin, Sr. discloses a drain pan system for receiving water condensed on and flowing from an air conditioning coil, including a pan with a pan member for receiving and holding water from the coil, and the pan member having a side lip for connecting to an adjacent pan, the adjacent pan adjacent the coil and disposed at an angle to the pan member. In one aspect, the drain pan is used with the coil which is generally con FIG. d in a V-shape when viewed from an end thereof. In one aspect, the system includes a lateral pan or pans sealingly connectible to the adjacent pan and to which the pan member is sealingly secured.

U.S. Pat. No. 5,284,027, issued Feb. 8, 1994, to Martin, Sr. discloses a drain pan with an opening or openings through which air flows to a coil and a coil which, in one embodiment, has a cover plate so air flowing through a drain pan flows between vanes of a coil rather than out from an opening at an end of the coil; such a pan in combination with such a coil; and a system with such a coil-pan combination which uses a single pan for multiple orientations of the coil-pan combination in both horizontal flow, up-flow, and down-flow systems.

U.S. Pat. No. 4,665,806, issued Sep. 12, 1985, to Martin, Sr. discloses An air distributor for mounting in a duct outlet in an air conditioning heating and ventilation system is provided to direct the flow of air within the conditioned space. A frame is mounted within the conditioned space and in fluid communication with the outlet of the duct. The frame has an opening therethrough. A deflection member is movably mounted to the frame from an open position wherein the air can flow into the conditioned space to a closed position where essentially no air flows into the conditioned space. The deflection member is selectively adjustable in intermediate positions between the open and closed positions. A diverter is provided with the deflection member and is accessible for adjustment from the conditioned space to selectively direct the air flow between the frame and deflection member into the conditioned space in a two way, three way and four way pattern.

U.S. Patent Publication No. 20050047974, published Mar. 3, 2005, to Martin, Sr., discloses a plenum system with air flow structure for enclosing a coil of an air treatment system. The air flow structure in certain aspects has a container with at least two openings for air flow therethrough, the container having an interior surface, and the interior surface having ultraviolet-resistant material thereon; and methods for using such an air flow structure.

U.S. Pat. No. 5,927,096, entitled “Air conditioning System and Method,” issued to Piccione, discloses an air conditioning apparatus and method which provides for a bi-flow coil housing having air flow connection ends that are substantially identical. These coil housing features allow the coil housing to be con FIG. d to have either a right-hand or left-hand coil configuration to thereby allow installation flexibility so that the coil refrigerant and drain connections are readily available. In furtherance of this feature, a transition member and a plenum have substantially similar or identical ends for connection to the coil housing and may be connected to either end of the coil housing. Because there is only one end of the transition member that will vary in size thereby greatly reducing the number of different possible combinations of connection sizes the transition member must accord, a plurality of prefabricated transition members are preferably stored in the warehouse based on the type of heater. The use of a prefabricated transition member specifically designed for the specific type of heater and coil housing provides a quicker and precision fit there between.

The solutions to the above described and/or related problems have been long sought without success. Consequently, there remains a need to provide equipment and methods for coils and mounting methods. Those of skill in the art will appreciate the present invention, which addresses the above problems and other significant problems uncovered by the inventor that are discussed hereinafter.

### SUMMARY OF THE INVENTION

It is an object of the invention to provide an improved air conditioning system.

Accordingly, an air conditioning system in accord with the present invention may comprise an evaporator coil and a housing surrounding the evaporator coil wherein the housing defines at least one input for airflow therethrough. A primary drain pan may be formed within the housing positioned to receive condensate from the evaporator coil. At least one auxiliary drain pan is formed within the housing for receiving overflow from the primary drain pan. The primary drain pan and the auxiliary drain pan may be plumbed or leveled with respect to each other during manufacturing to avoid the need to perform this function twice.

In one embodiment, the auxiliary drain pan may be utilized as the bottom or part of the bottom of the housing. Alternatively, the auxiliary drain pan may be positioned above a bottom of the housing. In one embodiment, the auxiliary drain pan may be positioned at least partially directly beneath the primary drain pan to receive overflow from the walls of the primary drain pan.

In one embodiment a plenum is interconnectable to the housing, and the at least one auxiliary drain pan is positioned in the plenum and/or the housing. Drain holes for the auxiliary drain pan may be formed in the plenum. The primary drain pan and/or the auxiliary drain pan may comprise metal, plastic, fiberglass, other suitable materials, and/or composite materials.

The present invention provides a method for making an air conditioning system which may comprise steps such as providing an evaporator coil, mounting a housing in surrounding relationship to the evaporator coil, and providing a primary drain pan within the housing positioned to receive condensate from the evaporator coil and/or providing at least one auxiliary drain pan formed within the housing for receiving overflow from the primary drain pan.

In one embodiment, the method may comprise providing that a drain pan bottom of the auxiliary drain pan also forms a bottom of the housing. In another embodiment, the method may comprise mounting the auxiliary drain pan at least partially directly above a bottom of the housing. Other steps may comprise mounting the auxiliary drain pan at least partially directly beneath the primary drain pan.

The method may provide an interconnectable plenum for the housing and/or provide that the auxiliary drain pan extends across an interconnection between a plenum and a coil housing.

### BRIEF DESCRIPTION OF DRAWINGS

For a further understanding of the nature and objects of the present invention, reference should be had to the following detailed description, taken in conjunction with the accompanying drawings, in which like elements may be given the same or analogous reference numbers and wherein:

FIG. 1 is a perspective view, partially in hidden lines, of an evaporator coil with plenum, primary, and auxiliary drain pans attached, wherein drain holes from the primary and auxiliary drain pan are shown in accord with a possible embodiment of the present invention.

FIG. 2 is a perspective view, partially in hidden lines, showing a primary and auxiliary drain pan in accord with a possible embodiment of the present invention.

FIG. 3A is a perspective view, in exploded configuration, showing an auxiliary drain pan integration with the plenum and/or coil and/or air conditioning housings in accord with a possible embodiment of the present invention.

FIG. 3B is a perspective view, partially in hidden lines, showing an auxiliary drain pan integration with the plenum and/or coil and/or air conditioning housings in accord with a possible embodiment of the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention.

### DETAILED DESCRIPTION OF THE PREFERRED EMBODIMENTS

The present invention provides an air conditioning system with drain pan assembly 10, hereinafter referred to as assembly 10, which may be utilized to more quickly and efficiently install the coil and related components used in an air-conditioning system. In one embodiment of the present invention, assembly 10 provides a single air conditioning housing to be installed, leveled and plumbed, having the full redundancy of an auxiliary pan, but without the need for an installer to fabricate and/or install one in the field. An air conditioning housing with integral drain pans and auxiliary drain pans in accord with the present invention addresses all the problems cited above with none of the aforementioned disadvantages.

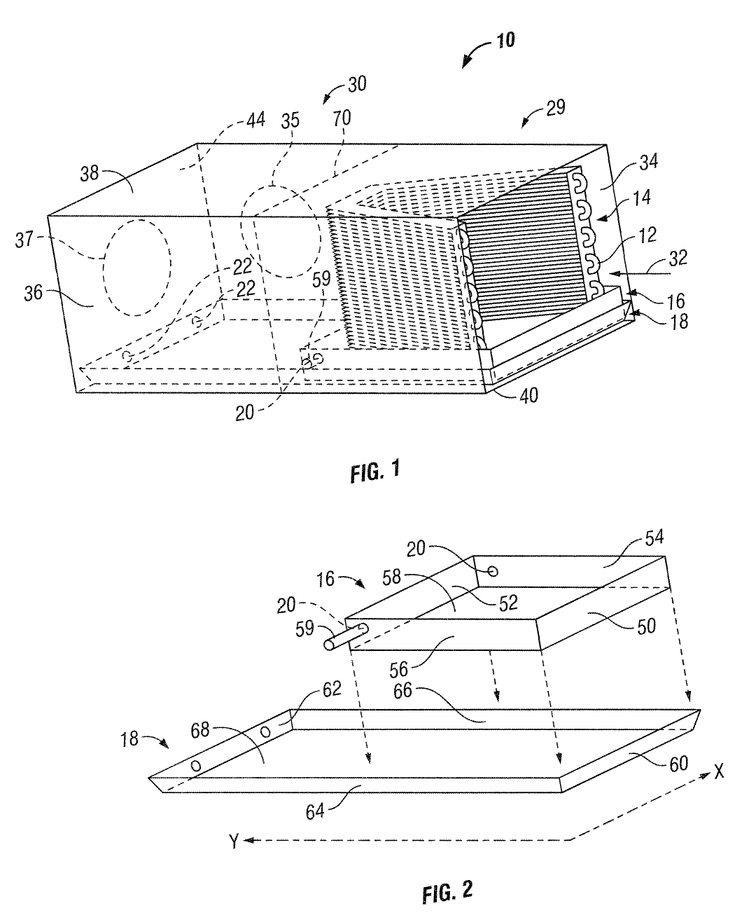

FIG. 1 illustrates one possible embodiment of an air conditioner with drain pan assembly 10. Many configurations of assembly 10 are possible. FIG. 1 shows one possible configuration of evaporator coil 14, which is in a horizontal V-shaped configuration. In this embodiment, coil housing 29 may incorporate coil 14. Coil 14 may comprise coils and fins 12 as is well known in the art. Other embodiments might possibly comprise an I-shaped, V-shaped, W-shaped, or other shapes of the evaporator coil in a horizontal configuration. Accordingly, FIG. 1 is an example configuration and is not intended to be comprehensive of every configuration contemplated.

Assembly 10 may comprise coil housing 29 and/or plenum 30. Plenum assembly 30 may be interconnectable to coil housing 29 utilizing, for example, junction or connection 70. Coil housing 29 and plenum portion 30 may also be reversible with respect to each other. Alternatively, coil housing 29 and plenum 30 may comprise a one-piece constriction housing. Thus, plenum assembly 30 may or may not incorporate or be incorporated with coil housing 29 and/or evaporator coil 14. In other words, the air conditioning housing may comprise coil housing 29 and/or plenum 30. The air conditioning housing components, such as coil 14 and/or coil housing 29 and/or plenum 30, may be secured together, separate, and/or formed in a one-piece construction, as desired.

In the embodiment of FIG. 1, air may enter assembly 10 through opening or air intake 34 as indicated by airflow arrow 32. Air then passes across evaporator coil 14, cooling the air. Air may be driven by a fan (not shown) through coil 14 into the plenum assembly 30. This cooled air then passes out of assembly 10 through at least one plenum air outlet, such as air outlets 35 and 37 or other outlets, which may be formed in walls 36 and 44. The cooled air is carried into a house or building to provide an air-conditioned space therein.

Air outlets, such as air outlet 37 on rear wall 44 or air outlet 35 on sidewall 36, may be provided or formed in plenum 30. Air may exit through any of the plenum sides as required. Plenum 30 may be comprised of material that is easily cut to form outlets as needed for the particular requirements of the air conditioning system for a particular house or building.

Heat transfers from the air through evaporator coil 14 and ultimately into the refrigerant. During this process, moisture condenses out of the air. Evaporator coil 14 is positioned above primary drain pan 16 and, depending on the configuration, over a portion or all of auxiliary drain pan 18. Auxiliary drain pan 18 may or may not extend over the entire length of assembly 10.

As primary drain pan 16 fills, the primary means of removing the recovered condensate is through the primary plenum drain holes 20. If an overflow occurs, such as if drain holes 20 become blocked, then condensate is recovered by a redundant system, auxiliary drain pan 18. The condensate may then be removed via the auxiliary plenum drain holes, such as auxiliary drain holes 22. Prior to any damage, the user may note that service is required when condensate flows from the auxiliary drain lines and/or other sensors may be available for this purpose.

In the illustrated embodiment, auxiliary drain pan 18 may preferably slope towards and drain out of back wall 44 through the auxiliary plenum drain holes 22. Other embodiments may comprise other drain holes, drain lines, and/or nozzles to carry condensate from auxiliary drain pan 18 and/or to carry condensate from primary drain pan 16 to one or more auxiliary drain pans 18. Furthermore, auxiliary drain pan 18 could be sloped towards, and drain out of, any of the slides 36, rear wall 44, or bottom 40. Alternatively, auxiliary drain pan 18 may not be sloped and may have a flat bottom.

FIG. 2 illustrates one possible embodiment of the integral drain pans. FIG. 2 is shown conceptually and actual construction may be of many different types and/or involve molds or the like. In this embodiment, primary drain pan 16 is comprised of front wall 50, rear wall 52, two side walls 54, 56, and a bottom 58. Primary drain pan 16 may be comprised of metal, plastic, fiberglass, combinations thereof, and/or any suitable materials. Primary drain pan 16 may overflow through primary plenum drain holes 20 into one or more drain lines 59.

Additionally, FIG. 2 shows possible relative dimensions of primary drain pan 16 and auxiliary drain pan 18. In one embodiment, the X and Y dimensions of the primary drain pan 16 may be less than those of the auxiliary drain pan 18. For example, primary drain pan 16 may fit or nest within the auxiliary drain pan 18. In the event of an overflow of primary drain pan 16, condensate flows over the walls 50, 52, 54, and 56 of the primary drain pan into the auxiliary drain pan 18. However, one or more walls may be lower than others to direct flow in a particular direction. As well, channels or openings may be formed and utilized to direct water from primary drain pan 16 to auxiliary drain pan 18. Auxiliary drain pan 18 and/or primary drain pan 16 may comprise a segmented pan, multiple pans, and/or channels therein to hold and/or direct flow of excess condensate.

Motivated by gravity, condensate drains out of the auxiliary drain pan holes 22. In the illustrated embodiment, the auxiliary drain pan holes 22 are located in the auxiliary drain pan rear wall 62. Other embodiments, however, may comprise auxiliary drain pan holes 22 in any of the drain pain walls 60, 62, 64, and/or 66. Other embodiments may comprise drain lines, tubes, nozzles, or valves, which interconnect with or lead from primary drain pan 16 and/or auxiliary drain pan 18.

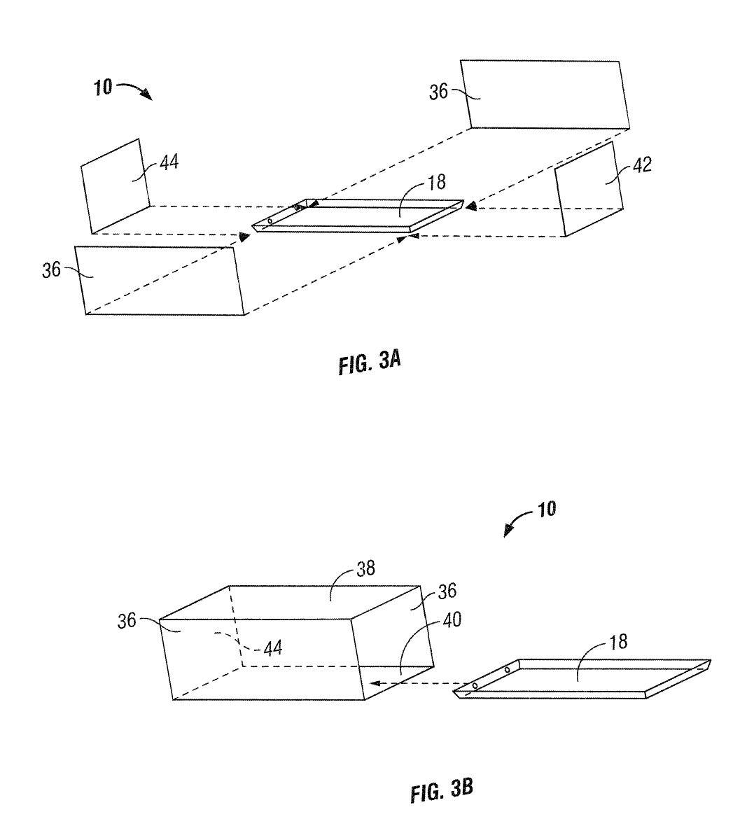

FIG. 3A and FIG. 3B illustrate further possible embodiments for assembly 10. In FIG. 3B, auxiliary drain pan 18 is a separate component that may be inserted onto the upper surface of bottom 40 of assembly 10 or some bottom portion of assembly 10. In FIG. 3B, assembly 10 (and/or coil housing 29 and/or plenum 30) might comprise a front wall 42, rear wall 44, top 38, bottom, and two sidewalls 36. Front wall 42 and rear wall 44 are shown for reference but may or may not be present and/or may be removable and/or may be suitable for modification or interconnection with coil housing 29 or plenum 30, depending on the configuration. As discussed hereinbefore, there are many possible configurations of assembly 10.

In FIG. 3A, the assembly 10 (and/or coil housing 29 and/or plenum 30) front 42, rear 44, and side walls 36 are fastened to the auxiliary drain pan 18, such that a bottom of auxiliary pan 18 becomes bottom 40 of assembly 10 or some portion of assembly 10.

In other embodiments, evaporator coil 14 and primary drain pan 16 may be formed in coil housing 29 and then attached as indicated by (possible) junction 70 in FIG. 1. A portion of auxiliary drain pan 18 may be provided in plenum 30 and another portion in coil housing 29 whereupon the portions of auxiliary drain pan 18 are interconnected by interconnecting plenum 30 and coil housing 29. In another embodiment, primary drain pan 16, evaporator coil 14, and auxiliary drain pan 18 may also be inserted into plenum 30. It will be appreciated that many different variations are possible. The manufacturing of auxiliary drain pan 18 and primary drain pan 16 results in the effective leveling and plumbing of these pans to cooperate with each other. Thus, in one embodiment, the installer may level and plumb assembly 10 one time, and complete the job in significantly less time with a higher quality construction.

Materials for plenum 30 and coil housing 29 may comprise thick or thin soft insulation, thick or thin rigid metal, thick or thin soft metal, and/or a combination of materials best suited for the application of the assembly 10. At least one surface of the plenum assembly 30 may be made of easily cut material to form air outlet(s) 35, 37 and/or other outlets as needed.

The embodiments discussed above accomplish the goal of having a single, integrated, plenum-coil-drain pan assembly. This single assembly reduces the time and costs associated with storing, transporting, installing, leveling, and plumbing individual components. The auxiliary drain pan and primary drain pan are plumb or level with respect to each other and the housing of the air-conditioning system so that it is only necessary to level the entire system one time.

Accordingly, the present invention provides primary and auxiliary drain pan arrangements, which can be installed at one time, eliminating significant time and expense.

The disclosure and description of the invention above is illustrative and explanatory of a presently preferred embodiment of the invention and variations thereof, and it will be appreciated by those skilled in the art that various changes in the design, organization, order of operation, means of operation, equipment structures and location, methodology, and use of mechanical/electrical/software equivalents, as well as in the details of the illustrated construction or combinations of features of the various elements, may be made without departing from the spirit of the invention.

As well, the drawings are intended to describe the concepts of the invention so that the presently preferred embodiments of the invention will be plainly disclosed to one of skill in the art but are not intended to be manufacturing level drawings or renditions of final products and may include simplified conceptual views as desired for easier and quicker understanding or explanation of the invention. As well, the relative size and arrangement of the components may be greatly different from that shown and still operate within the spirit of the invention as described hereinbefore and in the appended claims. It will be seen that various changes and alternatives may be used that are contained within the spirit of the invention.

Accordingly, because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative of a presently preferred embodiment and not in a limiting sense.

What is claimed is:

1. An air conditioning system, comprising:
an evaporator coil;
a housing surrounding said evaporator coil, said housing defining an input for airflow;
a primary drain pan formed within said housing positioned to receive condensate from said evaporator coil; and
at least one auxiliary drain pan formed within said housing and operatively in communication with said primary drain pan for receiving overflow from said primary drain pan.

2. The air conditioning system of claim 1, wherein said primary drain pan and said at least one auxiliary drain pan are plumb with respect to each other.

3. The air conditioning system of claim 1, wherein said at least one auxiliary drain pan forms a bottom of said housing.

4. The air conditioning system of claim 1, wherein said at least one auxiliary drain pan is positioned above a bottom of said housing.

5. The air conditioning system of claim 1, wherein said at least one auxiliary drain pan is positioned at least partially directly beneath said primary drain pan.

6. The air conditioning system of claim 1, wherein a plenum comprises at least a portion of said housing.

7. The air conditioning system of claim 1, wherein a plenum is interconnectable to said housing, and said at least one auxiliary drain pan is positioned at least partially in said plenum.

8. The air conditioning system of claim 6, wherein said at least one auxiliary drain pan extends into said plenum.

9. The air conditioning system of claim 6, wherein drain holes for said at least one auxiliary drain pan are formed in said plenum.

10. The air conditioning system of claim 1, wherein drain holes for said at least one auxiliary drain pan are formed in said housing.

11. The air conditioning system of claim 1, wherein said primary drain pan and said at least one auxiliary drain pan comprises one or more of metal, plastic, fiberglass, and composite materials.

12. The air conditioning system of claim 1, wherein said primary drain pan nests within said at least one auxiliary drain pan.

13. A method for making an air conditioning system, comprising steps of:
providing an evaporator coil;
mounting a housing in surrounding relationship to said evaporator coil;
defining at least one input for airflow through said housing;
providing a primary drain pan within said housing positioned to receive condensate from said evaporator coil; and
providing at least one auxiliary drain pan within said housing operatively in communication with said primary drain pan for receiving condensate from said primary drain pan.

14. The method of claim 13, providing that a drain pan bottom of said at least one auxiliary drain pan also forms a bottom of said housing.

15. The method of claim 13, mounting said at least one auxiliary drain pan at least partially directly above a bottom of said housing.

16. The method of claim 13, securing at least a portion of said primary drain pan within said at least one auxiliary drain pan.

17. The method of claim 13, providing an interconnectable plenum for said housing.

18. The method of claim 13, providing that said at least one auxiliary drain pan extends from said input of said housing into a plenum.

19. The method of claim 13, forming drain holes for said at least one auxiliary drain pan in a plenum.

20. The method of claim 13, forming drain holes for said at least one auxiliary drain pan in said housing.
